(19) United States
(12) Patent Application Publication
(10) Pub. No.: US 2025/0249574 A1
(43) Pub. Date: Aug. 7, 2025

(54) TECHNIQUES FOR ROBOT CONTROL USING MULTI-MODAL USER INPUTS

(71) Applicant: NVIDIA CORPORATION, Santa Clara, CA (US)

(72) Inventors: Yanwei WANG, Cambridge, MA (US); Balakumar SUNDARALINGAM, San Jose, CA (US); Xuning YANG, Seattle, WA (US); Yu-Wei CHAO, Redmond, WA (US); Claudia PEREZ D’ARPINO, Seattle, WA (US); Dieter FOX, Seattle, WA (US)

(21) Appl. No.: 18/665,271

(22) Filed: May 15, 2024

Related U.S. Application Data
(60) Provisional application No. 63/549,966, filed on Feb. 5, 2024.

(51) Int. Cl. B25J 9/00; B25J 9/16

(52) U.S. Cl. CPC B25J 9/0081; B25J 9/163; B25J 9/1664

(57) ABSTRACT

Techniques for robot control using multi-modal user inputs include receiving one or more multi-modal inputs from a user, extracting a motion hint from the one or more multi-modal inputs, generating estimated noise based on a current motion scene for the robot, generating a plurality of candidate motion plans, iteratively denoising the plurality of candidate motion plans based on the estimated noise and the motion hint to generate a plurality of revised robot motion plans, selecting a robot motion plan from the plurality of revised robot motion plans, generating a robot trajectory from the selected robot motion plan; and commanding the robot to perform a first step of the robot trajectory.

### CROSS-REFERENCE TO RELATED APPLICATIONS

This application claims priority benefit of the U.S. Provisional Patent Application titled, “TECHNIQUES FOR EDITING MOTION PLANS USING MULTI-MODAL PROMPTS,” filed on Feb. 5, 2024, and having Ser. No. 63/549,966. The subject matter of this related application is hereby incorporated herein by reference.

### BACKGROUND

### Technical Field

Embodiments of the present disclosure relate generally to robot control and, more specifically, to techniques for editing robot motion plans using multi-modal user inputs.

### Description of the Related Art

Robot control is a branch of artificial intelligence that deals with directing the actions of robots. Robot control involves various techniques for instructing robots on how to carry out tasks, manage movements, and respond to the operational environment. Robot motion planning, a subfield of robot control, is concerned with designing the paths that robots follow to achieve the programmed tasks, such as manipulating objects, navigating spaces, and/or the like. Robot motion planning includes creating a sequence of coordinated movements that allows robots to execute functions, such as picking up items, moving items from one location to another, positioning items, and/or the like. Conventional robot motion planning techniques are grounded in trajectory generation, which includes the formulation of a set of movements that a robot executes to transition from an initial state to a desired end state. Trajectory generation typically includes defining the velocity, acceleration, and pose (e.g., position and/or orientation) of the robot or portions of the robot at various points in time, and then producing a continuous and smooth path. The robot trajectories are calculated to optimize certain aspects of movement, such as minimizing travel time or energy consumption, while adhering to the robot's kinematic and dynamic constraints.

Conventional robot motion planning techniques using human guidance, such as learning from expert demonstrations, Inverse Reinforcement Learning (IRL), and/or the like, represents an extension over other conventional robot motion planning techniques that allow human input to aid in the acquisition and refinement of robot motion plans. By observing the actions of human experts, robot motion planning techniques enable robots to mimic complex robot motions that can be difficult to engineer explicitly through trajectory planning alone. For example, IRL seeks to understand the underlying objectives that guide the behavior of human experts. A subset of conventional robot motion planning techniques using human guidance include online human interaction with generative models in the computer vision domain, which offer innovative approaches to image modification and creation. A prominent example is “DragGan,” which introduces an intuitive interface allowing human users to click and drag pixels to effectuate desired changes, such as enlarging an element within an image. The process is powered by a Generative Adversarial Network (GAN) and emphasizes a unimodal, direct human interaction technique.

One drawback of the conventional robot motion planning techniques using human guidance is that these techniques heavily rely on the availability and endurance of human users for data collection. Specifically, mirroring complex or physically demanding tasks to teach robots can be exhaustive for the users involved. When users perform robot tasks, users have to do so repeatedly to generate sufficient data for the robot to learn effectively. The repetition can lead to physical fatigue and can even result in decreased performance or variability in the demonstrations over time.

Another drawback of the conventional robot motion planning techniques using human guidance, particularly, the techniques involving online human interaction, is the unimodal interaction design. Conventional techniques involving online human interaction typically allow human users to adjust through a singular mode of interaction, such as clicking and dragging pixels to alter an image's elements. The unimodal approach, while straightforward and effective for simple modifications, can limit the richness and variety of user inputs that can be accommodated. For example, conventional techniques do not easily allow for the incorporation of verbal instructions or gestures that could convey subtler nuances of the desired robot motions.

As the foregoing illustrates, what is needed in the art are more effective techniques for robot control using multi-modal user inputs.

### SUMMARY

According to some embodiments, a computer-implemented method for controlling a robot includes receiving one or more multi-modal inputs from a user, extracting a motion hint from the one or more multi-modal inputs, generating estimated noise based on a current motion scene for the robot, generating a plurality of candidate motion plans, iteratively denoising the plurality of candidate motion plans based on the estimated noise and the motion hint to generate a plurality of revised robot motion plans, selecting a robot motion plan from the plurality of revised robot motion plans, generating a robot trajectory from the selected robot motion plan; and commanding the robot to perform a first step of the robot trajectory.

Further embodiments provide, among other things, non-transitory computer-readable storage media storing instructions and systems configured to implement the method set forth above.

At least one technical advantage of the disclosed techniques relative to the prior art is that, with the disclosed techniques, the need for strong and detailed human input during the robot motion planning process is removed. The disclosed techniques do not require extensive human interaction, which is often repetitive and physically demanding for a user, and instead work from easy to generate multi-modal user inputs that indicate the desired intent of the user without being physically demanding. In addition, the multi-modal user inputs give the user more flexibility when providing a motion hint over conventional techniques using only unimodal user inputs. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 illustrates a block diagram of a computer-based system configured to implement one or more aspects of the various embodiments;

FIG. 5 is a more detailed illustration of the model trainer of FIG. 4, according to various embodiments;

FIG. 6 is a more detailed illustration of the robot control application of FIG. 4, according to various embodiments;

FIG. 7A illustrates an example of robot control without multi-modal user input(s) using robot control application of FIG. 6, according to various embodiments;

FIGS. 7B and 7C illustrate examples of robot control using multi-modal user input(s) using robot control application of FIG. 6, according to various embodiments;

FIG. 8 is a flow diagram of method steps for training the generative machine learning model used during the control of a robot, according to various embodiments;

FIG. 9 is a flow diagram of method steps for using multi-modal user input(s) and a trained generative machine learning model to control a robot, according to various embodiments; and

FIG. 10 is a flow diagram of method steps for interactive denoising to generate revised robot motion plans, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### Computing System Overview

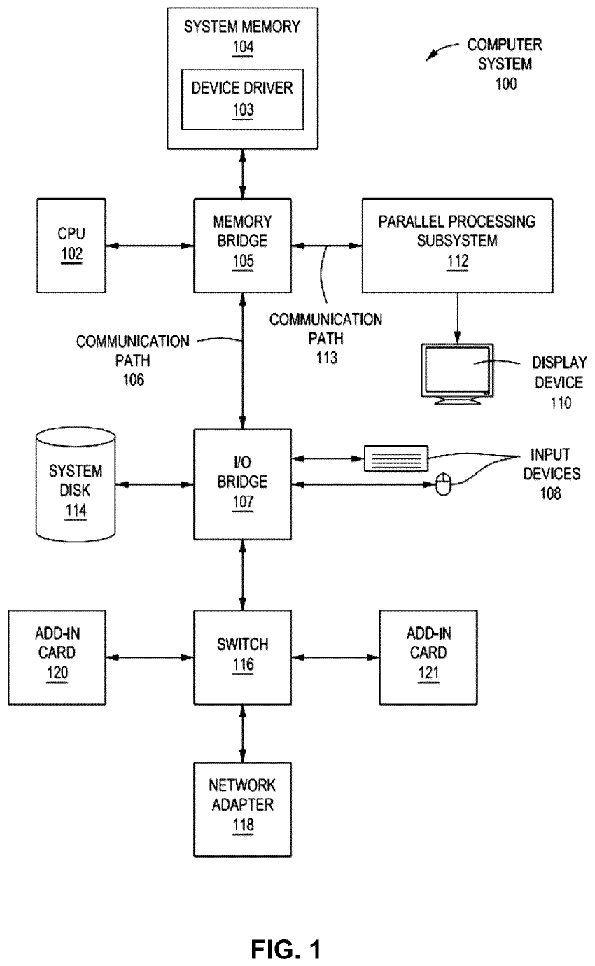

FIG. 1 is a block diagram of a computer system 100 configured to implement one or more aspects of various embodiments. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case can be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add in cards 120 and 121.

As also shown, I/O bridge 107 is coupled to a system disk 114 that can be configured to store content and applications and data for use by CPU 102 and parallel processing subsystem 112. As a general matter, system disk 114 provides non-volatile storage for applications and data and can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, can be connected to I/O bridge 107 as well.

In various embodiments, memory bridge 105 can be a Northbridge chip, and I/O bridge 107 can be a Southbridge chip. In addition, communication paths 106 and 113, as well as other communication paths within computer system 100, can be implemented using any technically suitable protocols, including, without limitation, AGP (Accelerated Graphics Port), HyperTransport, or any other bus or point to point communication protocol known in the art.

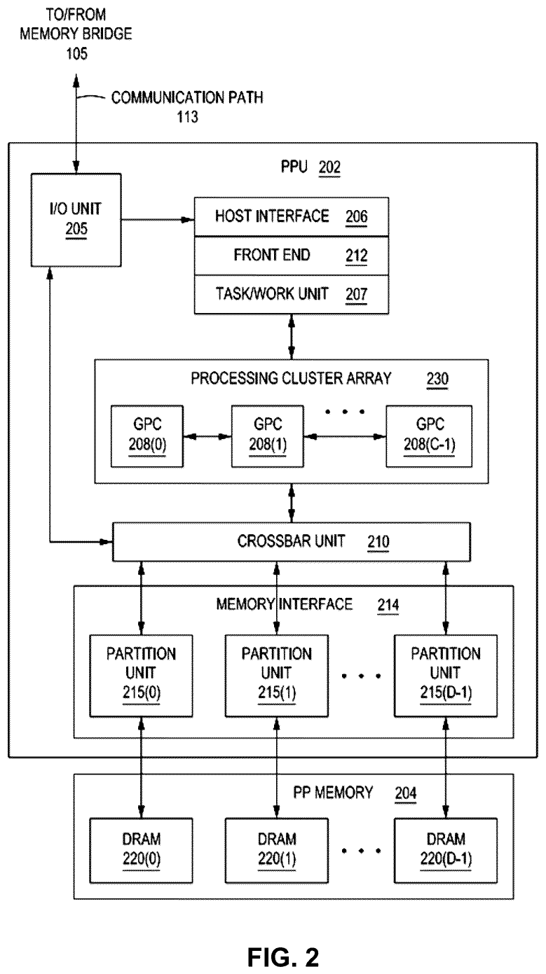

In some embodiments, parallel processing subsystem 112 comprises a graphics subsystem that delivers pixels to a display device 110 that can be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry can be incorporated across one or more parallel processing units (PPUs) included within parallel processing subsystem 112. In other embodiments, the parallel processing subsystem 112 incorporates circuitry optimized for general purpose and/or compute processing. Again, such circuitry can be incorporated across one or more PPUs included within parallel processing subsystem 112 that are configured to perform such general purpose and/or compute operations. In yet other embodiments, the one or more PPUs included within parallel processing subsystem 112 can be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 can be integrated with one or more other the other elements of FIG. 1 to form a single system. For example, parallel processing subsystem 112 can be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, can be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 can be connected to I/O bridge 107 or directly to CPU 102, rather than to memory bridge 105. In still other embodiments, I/O bridge 107 and memory bridge 105 can be integrated into a single chip instead of existing as one or more discrete devices. Lastly, in certain embodiments, one or more components shown in FIG. 1 can not be present. For example, switch 116 could be eliminated, and network adapter 118 and add in cards 120, 121 would connect directly to I/O bridge 107.

FIG. 2 is a block diagram of a parallel processing unit (PPU) 202 included in the parallel processing subsystem 112 of FIG. 1, according to various embodiments. Although FIG. 2 depicts one PPU 202, as indicated above, parallel processing subsystem 112 can include any number of PPUs 202. As shown, PPU 202 is coupled to a local parallel processing (PP) memory 204. PPU 202 and PP memory 204 can be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that can be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 can be used to store and update pixel data and deliver final pixel data or display frames to display device 110 for display. In some embodiments, PPU 202 also can be configured for general purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that can be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities can be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks can be directed to a host interface 206, while commands related to memory operations (e.g., reading from or writing to PP memory 204) can be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 can be varied. In some embodiments, parallel processing subsystem 112, which includes at least one PPU 202, is implemented as an add in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 can be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that can be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority can be specified for each TMD that is used to schedule the execution of the processing task. Processing tasks also can be received from the processing cluster array 230. Optionally, the TMD can include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C □ 1. Each GPC 208 is capable of executing a large number (e.g., hundreds or thousands) of threads concurrently, where each thread is an instance of a program. In various applications, different GPCs 208 can be allocated for processing different types of programs or for performing different types of computations. The allocation of GPCs 208 can vary depending on the workload arising for each type of program or computation.

Memory interface 214 includes a set of D of partition units 215, where D □ 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 can be different than the number of DRAMs 220. Persons of ordinary skill in the art will appreciate that a DRAM 220 can be replaced with any other technically suitable storage device. In operation, various render targets, such as texture maps and frame buffers, can be stored across DRAMs 220, allowing partition units 215 to write portions of each render target in parallel to efficiently use the available bandwidth of PP memory 204.

A given GPCs 208 can process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 can use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data can then be accessed by other system components, including CPU 102, another PPU 202 within parallel processing subsystem 112, or another parallel processing subsystem 112 within computer system 100.

As noted above, any number of PPUs 202 can be included in a parallel processing subsystem 112. For example, multiple PPUs 202 can be provided on a single add in card, or multiple add in cards can be connected to communication path 113, or one or more of PPUs 202 can be integrated into a bridge chip. PPUs 202 in a multi PPU system can be identical to or different from one another. For example, different PPUs 202 might have different numbers of processing cores and/or different amounts of PP memory 204. In implementations where multiple PPUs 202 are present, those PPUs can be operated in parallel to process data at a higher throughput than is possible with a single PPU 202. Systems incorporating one or more PPUs 202 can be implemented in a variety of configurations and form factors, including, without limitation, desktops, laptops, handheld personal computers or other handheld devices, servers, workstations, game consoles, embedded systems, and the like.

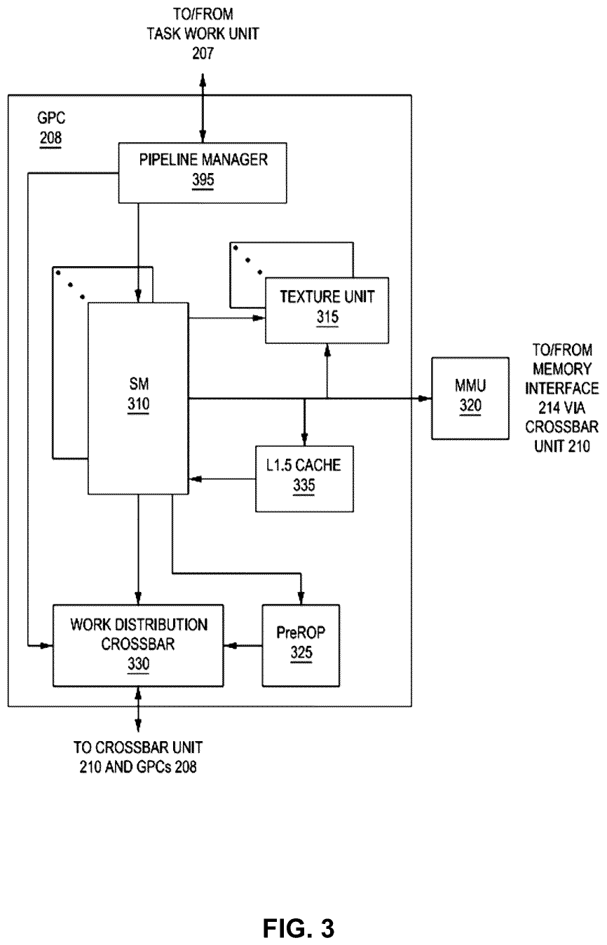

FIG. 3 is a block diagram of a GPC 208 included in PPU 202 of FIG. 2, according to various embodiments. In operation, GPC 208 can be configured to execute a large number of threads in parallel to perform graphics, general processing and/or compute operations. As used herein, a “thread” refers to an instance of a particular program executing on a particular set of input data. In some embodiments, single instruction, multiple data (SIMD) instruction issue techniques are used to support parallel execution of a large number of threads without providing multiple independent instruction units. In other embodiments, single instruction, multiple thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 can also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units can be pipelined, which enables a new instruction to be issued for execution before a previous instruction has completed execution. Any combination of functional execution units within a given SM 310 can be provided. In various embodiments, the functional execution units can be configured to support a variety of different operations including integer and floating point arithmetic (e.g., addition and multiplication), comparison operations, Boolean operations (AND, OR, XOR), bit shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group can include fewer threads than the number of execution units within the SM 310, in which case some of the execution can be idle during cycles when that thread group is being processed. A thread group can also include more threads than the number of execution units within the SM 310, in which case processing can occur over consecutive clock cycles. Since each SM 310 can support up to G thread groups concurrently, it follows that up to G*M thread groups can be executing in GPC 208 at any given time.

Additionally, a plurality of related thread groups can be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches can be used to transfer data between threads. Finally, SMs 310 also have access to off chip “global” memory, which can include PP memory 204 and/or system memory 104. It is to be understood that any memory external to PPU 202 can be used as global memory. Additionally, as shown in FIG. 3, a level one-point-five (L1.5) cache 335 can be included within GPC 208 and configured to receive and hold data requested from memory via memory interface 214 by SM 310. Such data can include, without limitation, instructions, uniform data, and constant data. In embodiments having multiple SMs 310 within GPC 208, the SMs 310 can beneficially share common instructions and data cached in L1.5 cache 335.

Each GPC 208 can have an associated memory management unit (MMU) 320 that is configured to map virtual addresses into physical addresses. In various embodiments, MMU 320 can reside either within GPC 208 or within the memory interface 214. The MMU 320 includes a set of page table entries (PTEs) used to map a virtual address to a physical address of a tile or memory page and optionally a cache line index. The MMU 320 can include address translation lookaside buffers (TLB) or caches that can reside within SMs 310, within one or more L1 caches, or within GPC 208.

In graphics and compute applications, GPC 208 can be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, can be included within GPC 208. Further, as described above in conjunction with FIG. 2, PPU 202 can include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of various embodiments.

### Robot Control System

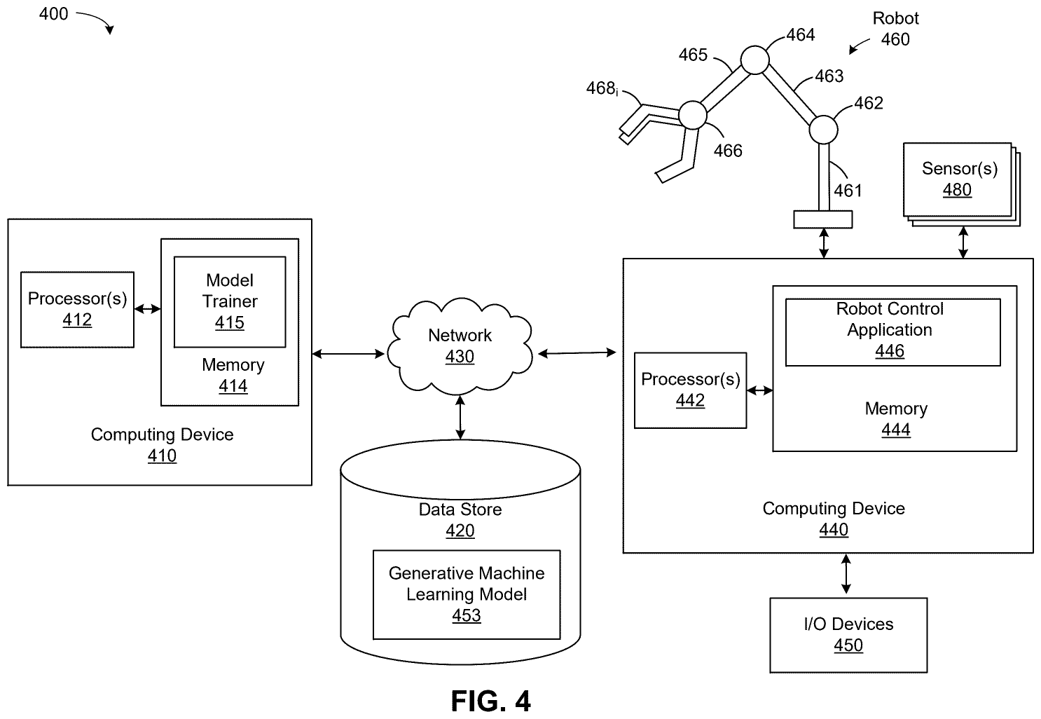

FIG. 4 illustrates a block diagram of a computer-based system 400 configured to implement one or more aspects of at least one embodiment. As shown, system 400 includes, without limitation, computing devices 410 and 440, a data store 420, a network 430, one or more I/O devices 450, a robot 460, and one or more sensors 480. Computing device 410 includes, without limitation, one or more processors 412 and memory 414. Memory 414 includes, without limitation, a model trainer 415. Datastore includes, without limitation, a generative machine learning model 453. Computing device 440 includes, without limitation, one or more processors 442 and memory 444. Memory 444 includes, without limitation, a robot control application 446. Robot 460 includes, without limitation, links 461, 463, and 465, joints 462, 464, and 466, and multiple fingers 468.

Computing device 410 shown herein is for illustrative purposes only, and variations and modifications are possible, including architectures described in FIGS. 1-3, without departing from the scope of the present disclosure. For example, the number of processors 412, the number of GPUs and/or other processing unit types, the number of and/or type of memories 414, and/or the number of applications included in the memory 414 can be modified as desired. Further, the connection topology between the various units in FIG. 4 can be modified as desired. In some embodiments, any combination of processor(s) 412, memory 414, and/or GPU(s) can be included in and/or replaced with any type of virtual computing system, distributed computing system, and/or cloud computing environment, such as a public, private, or a hybrid cloud system.

Processor(s) 412 can be any suitable processor, such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. In general, processors 412 can be any technically feasible hardware unit capable of processing data and/or executing software applications. During operation, processor(s) 412 receive user input from input devices (not shown), such as a keyboard or a mouse.

Memory 414 of computing device 410 stores content, such as software applications and data, for use by processor(s) 412. As shown, memory 414 includes model trainer 415. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

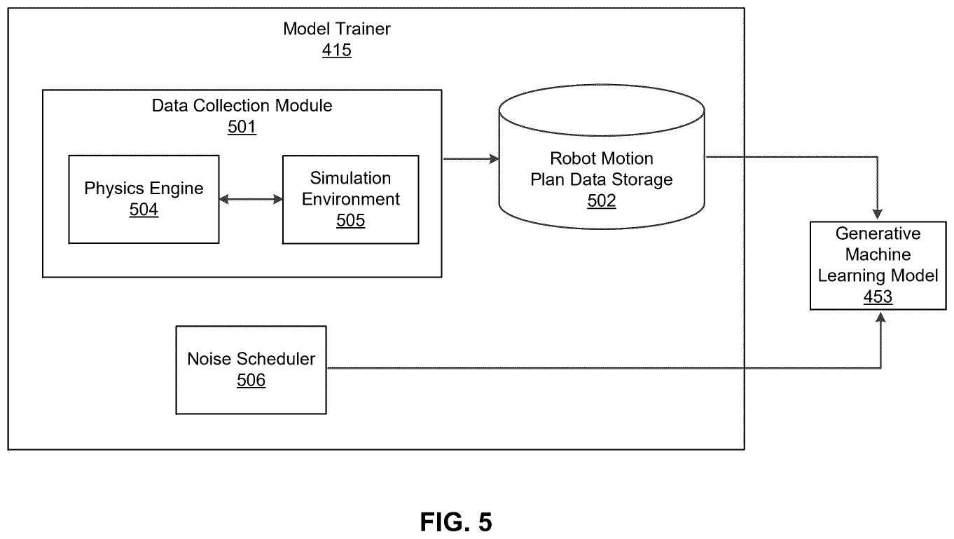

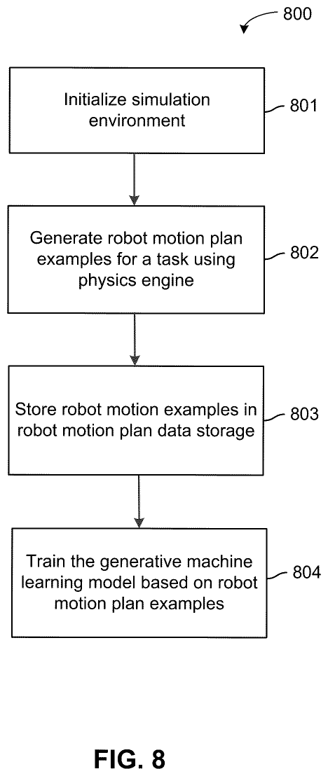

Model trainer 415 is stored in memory 414 and is executed by processor(s) 412. Model trainer 415 is configured to train one or more machine learning models, such as generative machine learning model 453, that are used to assist in the control of a robot, such as robot 460, to perform a task. Model trainer 415 can employ any suitable techniques to train the machine learning model(s). For example, model trainer 415 can use supervised learning, unsupervised learning, reinforcement learning, deep learning, and/or the like to train the machine learning model(s). Model trainer 415 is discussed in greater detail below in conjunction with FIGS. 5 and 8. After model trainer 415 trains generative machine learning model 453, model trainer 415 stores generative machine learning model 453 in data store 420 for access by other computing devices, such as computing device 440.

Data store 420 can include any storage device or devices, such as fixed disc drive(s), flash drive(s), optical storage, network attached storage (NAS), and/or a storage area-network (SAN). Although shown as accessible over network 430, in some embodiments computing device 410 can include data store 420. As shown, data store 420 includes generative machine learning model 453.

Generative machine learning model 453 is a data-driven model, which includes a set of parameters that have been optimized by model trainer 415 to assist in the generation of robot motion plans for robot 460. For example, generative machine learning model 453 can be a diffusion model, which incrementally learns to generate the noise that was added to robot motion plan data during training. Other examples of models suitable for generative machine learning model 453 include Variational Autoencoders (VAEs), GANs and autoregressive models, such as Transformers, and/or the like. In various embodiments, the parameters of generative machine learning model 453 are typically learned using backpropagation and stored in data store 420. In at least one embodiment, the parameters can be updated as new data becomes available, as the task requirements for robot 460 evolve, as the multi-modal user input(s) are received from one or more I/O device(s) 108. Once trained, generative machine learning model 453 can be deployed in any suitable manner, such as via robot control application 446.

Network 430 can be a wide area network (WAN), such as the Internet, a local area network (LAN), a cellular network, and/or any other suitable network. Computing devices 410 and 440 and data store 420 are in communication over network 430. For example, network 430 can include any technically feasible network hardware suitable for allowing two or more computing devices to communicate with each other and/or to access distributed or remote data storage devices, such as data store 420.

Computing device 440 shown herein is for illustrative purposes only, and variations and modifications are possible, including architectures described in FIGS. 1-3, without departing from the scope of the present disclosure. For example, the number of processors 442, the number of GPUs and/or other processing unit types, the number of memories 444, and/or the number of applications included in the memory 444 can be modified as desired. Further, the connection topology between the various units in FIG. 4 can be modified as desired. In some embodiments, any combination of processor(s) 442, memory 444, and/or GPU(s) can be included in and/or replaced with any type of virtual computing system, distributed computing system, and/or cloud computing environment, such as a public, private, or a hybrid cloud system.

Processor(s) 442 can be any suitable processor, such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. In general, processors 442 can be any technically feasible hardware unit capable of processing data and/or executing software applications. During operation, processor(s) 442 receives user input from input devices (not shown), such as a keyboard or a mouse.

Memory 444 of computing device 440 stores content, such as software applications and data, for use by processor(s) 442. As shown, memory 444 includes robot control application 446. Memory 444 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 444. The storage can include any number and type of external memories that are accessible to processor(s) 442. For example, and without limitation, the storage can include a Secure Digital Card, an external Flash memory, a portable compact disc read-only memory (CD-ROM), an optical storage device, a magnetic storage device, and/or any suitable combination of the foregoing.

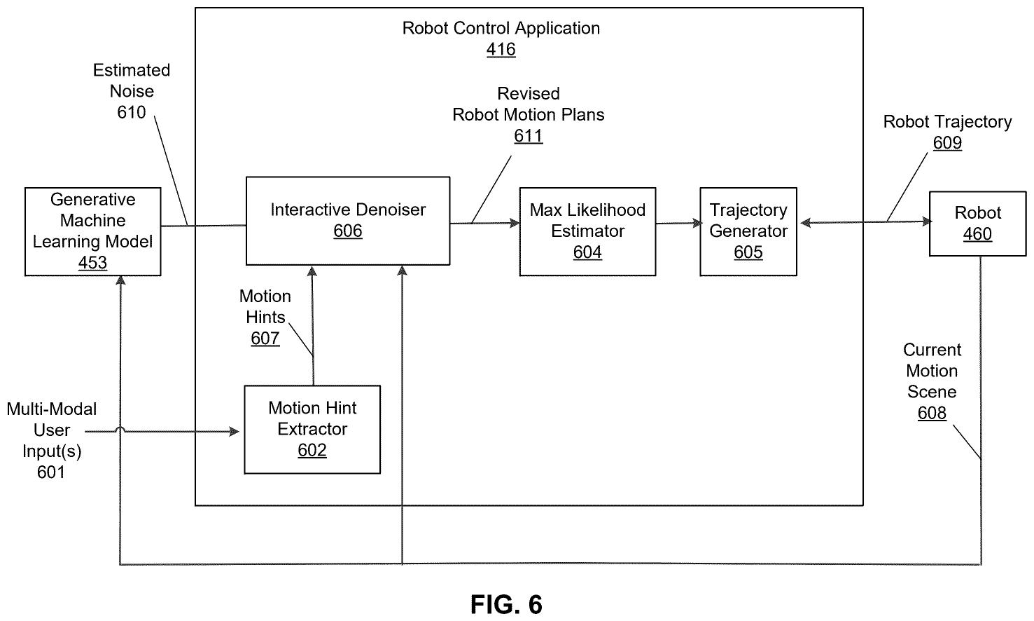

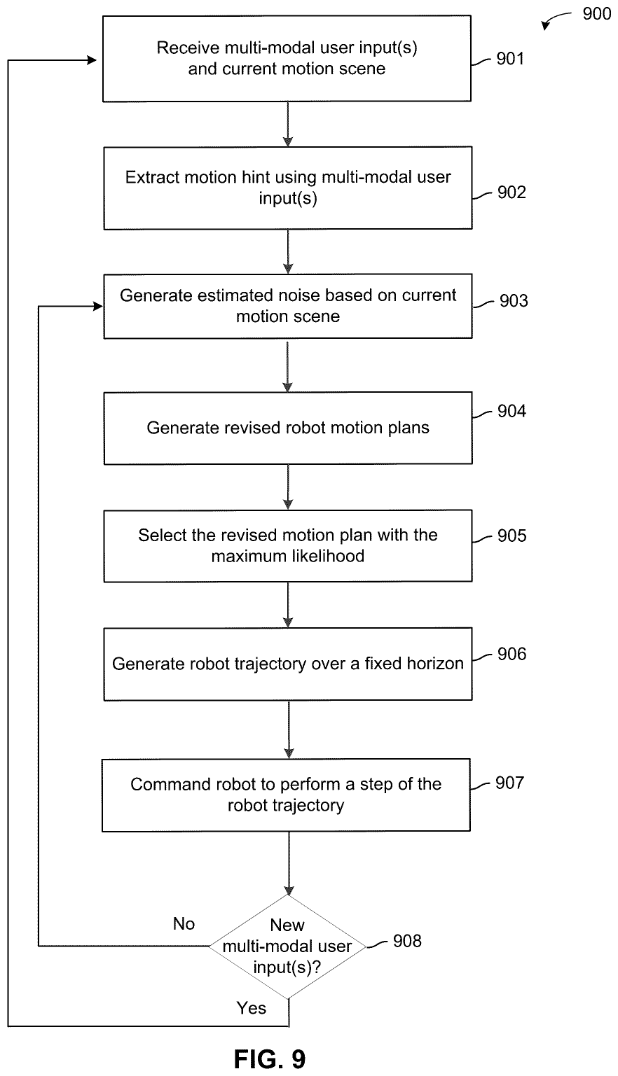

As shown, robot control application 446 that uses generative machine learning model 453 is stored in a memory 444, and executes on a processor(s) 442. Robot control application 446 is discussed in greater detail below in conjunction with FIGS. 6 and 9. Illustratively, given sensor data captured by one or more sensors 480 (e.g., force sensors, cameras), robot control application 446 uses generative machine learning model 453 to control robot 460 to perform one or more tasks for which generative machine learning model 453 was trained.

The one or more I/O devices 450 facilitate the interaction between computing device 440 with the external environment and/or users. In various embodiments, one or more I/O devices 450 receive multi-modal user inputs and communicates multi-modal user inputs to computing device 440. In various embodiments, one or more I/O devices 450 includes a telestrator for graphical input, allowing users to provide instructions via drawings and/or sketches. In at least one embodiment, the one or more I/O devices 450 include a 3D input system, such as Leap Motion, Microsoft Kinect, and/or the like, which captures spatial gestures, translating physical user movements into commands. In some embodiments, the one or more I/O devices 450 include one or more vision sensors to detect gestures. In some examples, one or more I/O devices 450 use various algorithms, such as image processing techniques, to interpret user gestures as specific commands. Additionally, the one or more I/O devices 450 can include microphones equipped with voice recognition technology, which allow for voice commands. In various embodiments, I/O devices 450 include, without limitation, output devices such as displays for visual feedback, speakers for auditory signals, indicator lights for status alerts, haptic devices for tactile feedback, and/or printers for producing physical records of operations of robot 460.

In some embodiments, the one or more sensors 480 can include a force sensor on a wrist of robot 460 that measures contact forces. Moreover, the one or more sensor(s) 480 can include joint sensors on each joint of the robot 460, such as joints 462, 464, and 466, that monitor the positions and velocities of the joints. For environmental perception, the one or more sensors 480 can include vision sensors, such as stereo cameras, LIDAR systems, and/or the like, that enable robot 460 to detect objects, assess distances, and/or perceive the operational environment by providing three-dimensional visual data.

As shown, robot 460 includes multiple links 461, 463, and 465 that are rigid members, as well as joints 462, 464, and 466, which are movable components that can be actuated to cause relative motion between adjacent links. Link 461 is mounted to a base at the proximal end of link 461, ensuring a stable connection to the foundation of robot 460. At the distal end, link 461 is coupled to link 463 via joint 462. Joint 462 is a movable component designed to actuate and facilitate the relative motion between link 461 and link 463. Similar to joint 462, joint 464 is situated at the distal end of link 463 and couples link 463 to link 465. Joint 466 couples link 465 to an end effector having multiple fingers 468 (referred to herein collectively as fingers 468 and individually as a finger 468) that can be controlled to grip an object. Each of joints 462, 464, and 466 can be any type of technically feasible joint, such as a prismatic joint or a revolute joint. Alternatively, in some embodiments, joint 466 is not moveable, such that robot 460 includes a locked wrist. Although an example robot 460 is shown for illustrative purposes, in some embodiments, techniques disclosed herein can be applied to control any suitable robot with any technically feasible combination of links and joints.

FIG. 5 is a more detailed illustration of model trainer 415 of FIG. 4, according to various embodiments. As shown, model trainer 415 includes, without limitation, a data collection module 501, robot motion plan data storage 502, and a noise scheduler 506. Data collection module 501 includes, without limitation, a physics engine 504 and a simulation environment 505. In operation, model trainer 415 trains generative machine learning model 453.

Data collection module 501 collects robot motion plan data that is used to train generative machine learning model 453. Additionally and/or alternatively, data collection module 501 collects robot motion plans based on observations and monitoring of a physical robot (not shown), while the physical robot performs various tasks. In some embodiments, data collection module 501 monitors the behavior of one or more simulated robot(s) in simulation environment 505, where the one or more robot(s) perform various tasks that emulate potential real-world task. In at least one embodiment, data collection module 501 collects the initial and final states of the one or more robots that indicate respective states of one or more robot(s) before initiating a task and after the completion of the task. In various embodiments, data collection module 501 identifies the various tasks performed by the one or more robots, such as picking up objects, placing objects at a designated location, navigating through a course, and/or the like. In various embodiments, data collection module 501 records robot trajectories that detail the path and movement of the one or more robots during the performance of the various tasks, such as positions and velocities. Data collection module 501 also determines task outcomes that indicate whether the robot succeeded or failed in completing a particular task, to provide feedback on the performance of the motion plans. In some embodiments, data collection module 501 collects robot motion plans from a variety of tasks to broaden the training data set, such as a “blocks world” scenario where one or more robots are tasked with stacking blocks in a specific pattern, an item retrieval task where the one or more robots have to locate, pick up, and transport objects from one place to another, a navigational task that requires one or more robot(s) to move through a simulated environment with obstacles, requiring real-time adjustments to the planned path, and/or the like.

Physics engine 504 is a computational framework designed to simulate the laws of physics with high fidelity. Physics engine 504 ensures that the virtual representations and movements of a robot account for a multitude of physical phenomena and constraints that affect both the robot and the objects within the workspace of the robot. Physics engine 504 ensures that the robot motion plans account for true-to-life physical interactions, which include but are not limited to factors such as inertia, gravity, friction, and/or the like as well as the specific mechanical properties of the robot, such as torque and force constraints, range of motion limits, and/or the like derived from a real robot, such as robot 460. For example, physics engine 504 can simulate the effect of varying payloads on the arm of the robot, or how the robot can adjust the trajectory when encountering an obstacle. In various embodiments, when the robot is interacting with multiple objects, physics engine 504 evaluates the stability of the items when stacked or combined. Physics engine 504 can predict whether an arrangement of objects is stable or will fall over. For example, physics engine 504 can simulate a scenario where the robot is stacking blocks. Physics engine 504 would determine if a particular stack configuration is stable or if a particular stack configuration has a high risk of collapsing under the weight of additional blocks or due to improper support for one or more of the blocks. Similar to the task of stacking blocks, when the robot is tasked with transporting a tray of items, physics engine 504 simulates the sway and potential slide of objects based on the speed and direction changes of the robot, allowing for adjustments to be made to the motion plan to ensure stable transport of the items on the tray.

Simulation environment 505 interacts with physics engine 504 to create a virtual workspace where one or more robots can perform tasks under controlled conditions. Simulation environment 505 can simulate various environments. For example, simulation environment 505 can simulate the one or more robots performing tasks on factory floors with precise, repetitive movements to dynamic, unpredictable settings that challenge the robot's adaptability. In some embodiments, simulation environment 505 simulates tasks that include but are not limited to object manipulation such as picking, sorting, assembling, stacking, and/or moving objects. Simulation environment 505 is supported by physics engine 504, which provides feedback on the forces and stability of the interactions. In at least one embodiment, simulation environment 505 can also simulate edge cases and failed robot tasks, such as accidentally dropping an object or encountering a runtime error, which are used to train a more robust and generalizable generative machine learning model 453. In some examples, simulation environment 505 includes the Isaac Sim™ robotic simulation platform developed by Nvidia Corporation, Santa Clara, CA.

Robot motion plan data storage 502 stores the robot motion examples generated by data collection module 501 as a training dataset for generative machine learning model 453. In some embodiments, the training dataset can each include robot poses, robot velocities, incremental robot Cartesian motion, diagonal entries of the stiffness matrix, contact forces, and/or the like. In various embodiments, the training dataset includes various motion scenes including but not limited to robot poses, robot positions, geometry of objects, and/or the like. In some embodiments, the training dataset include the shapes, sizes, and spatial relationships of the objects that the robot interacts with during the task as well as the layout of the workspace, including but not limited to the placement of objects and potential obstacles. In some embodiments, robot motion plan data storage 502 includes, without limitation, any technically feasible storage device or devices, such as fixed disc drive(s), flash drive(s), optical storage, network attached storage (NAS), and/or a storage area-network (SAN).

In some examples, generative machine learning model 453 includes a diffusion model. Training a diffusion model with robot motion, such as the robot motion examples stored in robot motion plan data storage 502, includes a process of gradually corrupting clean, structured robot motion examples stored in robot motion plan data storage 502 with noise and then learning to reverse the process to generate the original robot motion plans from the noisy data. The diffusion model starts with the robot motion plan examples stored in robot motion plan data storage 502 in a clean state represented as a high-dimensional vector X₀=(X₀[0], X₁[1], . . . , X₀[T])′, where T is a fixed motion plan horizon. In some examples, the diffusion process then adds noise, such as Gaussian noise, at each step in a sequence of N steps, gradually transforming the data into a completely noisy state X_{N}. Mathematically, the forward diffusion process is described by:

$${X}_{i} = \sqrt{1 - {β}_{i}} {X}_{i - 1} + \sqrt{{β}_{i}} {ϵ}_{i} , i = 1 , 2 , … , N \qquad ( Equation 1 )$$

where βᵢ is the variance of the noise added at step i, and ϵᵢ is a sample from a standard Gaussian distribution. During training, the diffusion model learns a reverse process that estimates the noise ϵᵢ at each step and iteratively removes the noise to generate the original data X₀. The reverse process includes training a parametric model, such as a neural network, ƒ_{θ}(Xᵢ, i) with parameters θ and conditioned on robot motion plan Xᵢ to predict the clean robot motion plans from the noisy data. For example, the parametric model can be trained by minimizing the following loss function:

$$ℒ ( θ ) = {\sum }_{i = 1}^{N} {𝔼}_{{X}_{θ , {ϵ}_{i}}} [ {‖ {ϵ}_{i} - {f}_{θ} ( {X}_{i} , i ) ‖}^{2} ] \qquad ( Equation 2 )$$

where [symbol] denotes the expectation over the clean robot motion plan examples stored in robot motion plan data storage 502 and noise distribution. To train the diffusion model, the gradients of the loss function in Equation 2 are calculated with respect to the parameters θ using backpropagation. The gradient determines how to change the parameters to reduce the error in the diffusion model's noise prediction, which is described as

$${∇}_{θ} ℒ ( θ ) = {\sum }_{i = 1}^{N} {𝔼}_{{X}_{θ , {ϵ}_{i}}} [ 2 ( {ϵ}_{i} - {f}_{θ} ( {X}_{i} , i ) ) \cdot {∇}_{θ} {f}_{θ} ( {X}_{i} , i ) ] . \qquad ( Equation 3 )$$

Using optimization algorithms, such as stochastic gradient descent (SGD), Adam, and/or the like, the parameters θ are updated iteratively in the direction that reduces the loss function in Equation 2:

$${θ}_{j + 1} ← {θ}_{j} - η \cdot {∇}_{{θ}_{j}} ℒ ( {θ}_{j} ) , \qquad ( Equation 4 )$$

where η>0 is the learning rate. The iterative training process, involving both the application of noise and the removal of noise, equips the diffusion model to generate accurate and adaptable robot motion plans based on the diverse scenarios presented in the training data.

Robot motion plan data storage 502 stores the robot motion examples used to train generative machine learning model 453. The Robot motion examples are generated by data collection module 501 from simulations of various tasks, such as stacking blocks, navigating obstacles, manipulating objects, and/or the like, using simulation environment 505 in interaction with physics engine 504. Robot motion examples includes, without limitation, robot poses, velocities, trajectories, and outcomes of tasks, detailing both successful and unsuccessful attempts. The clean, structured data, represented as X₀, is used to start the training process for the diffusion model.

Noise scheduler 506 determines the schedule and amount of noise added to the robot motion examples stored in robot motion plan data storage 502 during the training of generative machine learning model 453. Noise scheduler introduces noise, such as Gaussian noise, to the robot motion examples at each step of the training process. In some embodiments, noise scheduler 506 uses a predefined variance βᵢ for the noise at each training step, which is used to simulate various levels of data corruption. In at least one embodiment, noise scheduler 506 uses a cosine scheduler for the noise variance, where βᵢ increases and then decreases over the course of the training steps, following the mathematical function:

$${β}_{i} = \frac{ϵ}{2} ( 1 - cos ( \frac{i}{N} π ) ) \qquad ( Equation 5 )$$

where, i represents the current step in the training process, N is the total number of steps in the training cycle, and ϵ is a parameter that adjusts the overall scale of noise variance. With a cosine scheduler, generative machine learning model 453 experiences a wide range of noise levels, from mild to severe, which helps in learning to denoise and reconstruct the original motion plan data. For training diffusion models, the cosine scheduler exposes the diffusion model to varying degrees of data complexity and distortion.

FIG. 6 is a more detailed illustration of the robot control application 416 of FIG. 4, according to various embodiments. As shown in FIG. 6, robot control application 416 receives multi-modal user inputs(s) 601 and a current motion scene 608 to generate a robot trajectory 609 which is applied to robot 460. As shown, robot control application 416 includes, without limitation, a motion hint extractor 602, a max likelihood estimator 604, a trajectory generator 605, and an interactive denoiser 606.

Multi-modal user inputs 601 are received through the one or more I/O devices 450 and includes various user input commands. In some embodiments, multi-modal user inputs 601 includes tactile user inputs from touchscreens or digital pens, which allow the user to sketch motion plans or designate specific areas within the operational environment of robot 460. For example, tactile inputs can include the user drawing a trajectory on a touchscreen to direct robot 460 to follow a specific path, using a digital pen to circle regions of interest, such as goals, on a digital map of the operational environment of robot 460, and/or the like. In at least one embodiment, multi-modal user inputs 601 include user gestures, captured through advanced motion sensors or cameras included in the one or more I/O devices 450. The user gestures enable users to give commands with hand or body movements, offering a more intuitive and natural way of interaction. For example, gesture inputs can include a swipe of the hand to instruct the robot 460 to transition to the next phase of a task, a pointed finger to indicate a particular object for robot 460 to pick up, and/or the like. Additionally, multi-modal user inputs 601 include voice inputs, which are captured through microphones included in I/O devices 450, permitting users to issue verbal commands. For example, voice inputs can include a user saying “lift” to initiate an upward motion, “halt” to pause the actions of robot 460, or a sentence such as “pick up blue box” to indicate a goal, and/or the like.

Motion hint extractor 602 receives multi-modal user input(s) 601. In various embodiments, motion hint extractor 602 processes multi-modal user input(s) 601 and generates one or more motion hints 607 that are provided to interactive denoiser 606. In various embodiments, motion hint extractor 602 uses a mapping function [symbol] that transforms [symbol] , the set of all multi-modal user input(s) 601, into a form that interactive denoiser 606 can use:

$$ℋ : 𝒰 \to ℳ \qquad ( Equation 6 )$$

where [symbol] denotes the motion hints. In at least one embodiment, multi-modal user input(s) 601 includes motion sketches [symbol] ⊂ [symbol] . For example, the user can provide a sketch using the one or more I/O devices 450 indicating a desired motion plan for robot 460. The sketch, such as a sequence of points, vectors, and/or the like, is converted into a motion hint [symbol] ₛ by motion hint extractor 602. In some examples, motion hint extractor 602 interpolates the points of the sketch into a smooth path and normalizes the points according to the operational space of robot 460 and generates a desired motion plan, denoted by \hat{X}, which is then encoded into motion hint [symbol] ₛ. In various embodiments, gesture inputs are captured by the one or more I/O devices 450. Gesture inputs include but are not limited to hand swipes to change operational modes of robot 460, pointing gestures to identify an object or goal for manipulation, and/or the like. Motion hint extractor 602 uses various algorithms including but not limited to pre-defined motion primitives, image processing techniques, and/or the like to process gesture inputs and generate a desired motion plan, which is then encoded into a motion hint [symbol] _{G} In some embodiments, multi-modal user input(s) 601 include a verbal commands [symbol] ⊂ [symbol] , which includes but is not limited to task-specific keywords, phrases, and/or the like. In some examples, the verbal command can refer to objects or goals in the operational space of robot 460, such as “pick up the blue block”, “grab the red ball”, and/or the like. When multi-modal user input(s) 601 include verbal commands, natural language processing techniques, such as BERT, GPT, transformers, and/or the like, can be used by motion hint extractor 602 to extract relevant parameters or goals from the verbal commands and generate a desired motion plan \hat{X}, which is then encoded into a hint [symbol] _{V}. In at least one embodiment, motion hint extractor 602 uses trajectory generation techniques to generate a desired motion plan \hat{X} using the extracted relevant parameters or goals. In various embodiments, motion hint extractor 602 uses individual motion hints [symbol] _{S}, [symbol] _{G} and [symbol] _{V} to construct one or more composite motion hints 607 for interactive denoiser 606.

Trained generative machine learning model 453 receives current motion scene 608 and generates estimated noise 610. Current motion scene 608 includes but is not limited to the current state of robot 460, such as pose and velocities of each joint of robot 460, as well as the location of objects in the workspace. In some examples, generative machine learning model 453 is a trained diffusion model. Generative machine learning model 453 generates estimated noise 610 using the parametric function ƒ_{θ} encoded in generative machine learning model 452, which is trained to predict ϵᵢ from the robot motion plan data Xᵢ and the step i as:

$${ϵ}_{i}^{⋀} ∼ {f}_{θ} ( {X}_{i} , i ) \qquad ( Equation 7 )$$

where ϵ\hat{ }ᵢ is the estimate of the noise vector at step i, Xᵢ is the current state of the robot from motion scene 608 at step i, and i is the current step index. Estimated noise 610 is provided to interactive denoiser 606.

Interactive denoiser 606 receives estimated noise 610, motion hints 607, and current motion scene 608 and generates revised robot motion plans 611. Interactive denoiser 606 iteratively denoises robot motion plan candidates and then updates denoised motion plan candidates based on motion hints 607 in a reverse process from, i=N, N−1, . . . , 1. In various embodiments, initially at i=N, interactive denoiser 606 uses the state of robot 460 included in current motion scene 608 to generate random motion plan candidates starting from the state of robot 460, which are denoted X_{N}. In some examples, interactive denoiser 606 generates initial motion plan candidates from a probability distribution, such as normal distribution. Furthermore, in some examples, interactive denoiser 606 generates random goals in the operational environment of robot 460. Once interactive denoiser 606 generates the initial motion plan candidates, interactive denoiser 606 generates denoised motion plan candidates by denoising. In some examples, for every step i, i=N, N−1, . . . , 1, interactive denoiser 606 generates denoised motion plan candidates, denoted by Xᵢ, which are computed by reversing Equation 1 that was used to add noise during the training process:

$${X}_{i - 1} = \frac{{X}_{i} - \sqrt{{β}_{i}} {ϵ}_{i}^{⋀}}{\sqrt{1 - {β}_{i}}} \qquad ( Equation 8 )$$

Equation 8 subtracts the estimated noise (scaled by \sqrt{βᵢ}, where βᵢ is the variance of the noise at step i) from the current noisy robot motion plan Xᵢ, and then rescales the result to account for the diffusion dynamics governed by 1−βᵢ as described in Equation 1. Once interactive denoiser 606 generates the denoised motion plan candidates by denoising, interactive denoiser 606 computes the gradient of an interaction loss and updates the denoised motion plan candidates based on the gradient of interaction loss. In various embodiments, interactive denoiser 606 compares denoised robot motion plan candidates and the desired motion plan \hat{X} included in motion hints 607 by motion hint extractor 602 and computes an interaction loss. In some examples, interactive denoiser 606 uses the desired robot motion plan \hat{X} included in motion hint [symbol] and computes interaction loss d (Xᵢ, \hat{X}( [symbol] )), where d(⋅,⋅) is a distance measure, such as a vector norm, and/or the like, between the denoised motion plan candidate Xᵢ and the desired motion plan \hat{X} included in motion hint [symbol] ᵢ. In at least one embodiment, interactive denoiser 606 computes the following interaction loss:

$${ℒ}_{ℳ} ( {X}_{i} \vert ℳ ) = {\sum }_{i - 1}^{N} {𝔼}_{{X}_{0} , ℳ , {ϵ}_{i}} [ d ( {X}_{i} , \hat{X} ( ℳ ) ) ] . \qquad ( Equation 9 )$$

Interactive denoiser 606 computes the gradient of interaction loss and updates denoised motion plan candidates. In some examples, interactive denoiser 606 updates denoised motion plan candidates using Equation 10.

$${X}_{i - 1} ← {X}_{i - 1} - λ {∇}_{{X}_{i - 1}} ( {ℒ}_{ℳ} ( {X}_{i - 1} \vert M ) ) {\vert}_{\{ {X}_{i - 1} \}} \qquad ( Equation 10 )$$

where 0≤λ<1 is a parameter influencing the effect of multi-modal user input(s) 601. In at least one embodiment, λ is set to zero beyond a fixed number of steps, M, 1≤M<N, constraining the influence of multi-modal user input(s) 601 to a pre-set number of steps in the reverse process. In at least one embodiment, interactive denoiser 606 sets the beginning of denoised motion plan candidates (e.g., the first step) Xᵢ₋₁[0] to the state of robot 460 included in current motion scene 608 to ensure that the denoised motion candidates are relevant and directly applicable to robot 460 and the operational environment of robot 460. Setting the denoised motion plan candidates Xᵢ₋₁ to the state of robot 460 included in current motion scene 608, which is known as “inpainting”, aligns the beginning of the denoised motion plan candidates with the latest observed state of robot 460 and decreases any discrepancies between the denoised motion plan candidates and the state of robot 460. In some embodiments, interactive denoiser 606 optionally also set the final state of denoised motion plan candidates Xᵢ₋₁[T], where T>0 is the motion plan horizon, to the goal included in motion hints 607. Interactive denoiser 606 repeats the reverse process from i=N to i=1. Once interactive denoiser 606 reaches the last denoising step, interactive denoiser 606 generates revised robot motion plans 611, denoted by X₀.

Max likelihood estimator 604 processes revised robot motion plans 611 generated by interactive denoiser 606 and selects the revised robot motion plan with maximum likelihood. In various embodiments, max likelihood estimator 604 selects the robot motion plan X from X which has the highest probability and provides X to trajectory generator 605.

Trajectory generator 605 processes the revised motion plan X received from max likelihood estimator 604 and generates robot trajectory 609. In various embodiments, robot trajectory 609 includes but is not limited to joint positions, velocities, accelerations, timing, and/or the like. In some embodiments, trajectory generator 605 discretizes the revised robot motion plan in discrete time steps. Furthermore, trajectory generator 605 can use smoothing or interpolation to ensure that robot trajectory 609 is feasible for robot 460 to follow. For example, if the revised robot motion plan includes waypoints, cubic splines or polynomial interpolations can be used to generate smooth transitions between the waypoints. In at least one embodiment, trajectory generator 605 uses a model predictive controller (MPC) to generate a trajectory over the horizon T. Following the generation of robot trajectory 609, trajectory generator 605 applies one or more kinematic models of the robot 460 to accurately determine the joint commands for joints 462, 464, 466, and fingers 468. The one or more kinematic models consider the mechanical structure of robot 460 and the laws of motion to translate robot trajectory 609 into specific commands for each joint 462, 464, 466 and finger 468. Once the joint commands are established, the commands are relayed to the control system of robot 460, which directly commands the joints to execute one step of the robot trajectory 609.

The new current motion scene 608, which now reflects the new state of robot 460 after executing one step of robot trajectory 609, is fed back into the generative machine learning model 453 and the interactive denoiser 606. The user also monitors the state of robot 460 via one or more I/O devices 450 and can update multi-modal user input(s) 601 to provide additional input on the control of robot 460. The process then iterates, with each cycle revising the actions of robot 460 based on multi-modal user input(s) 601 as robot 460 performs various tasks.

### Robot Control Using Multi-Modal User Inputs

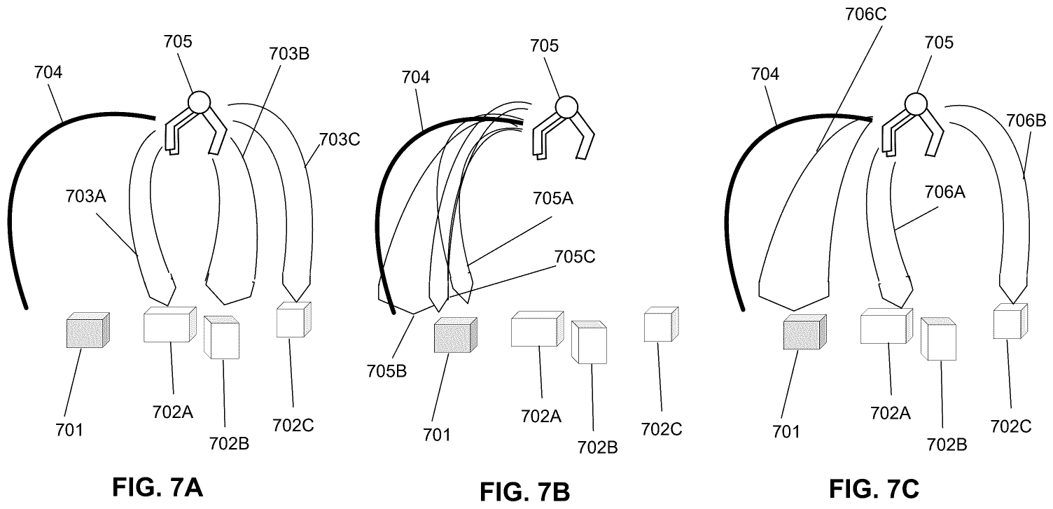

FIG. 7A illustrates an example of robot control without multi-modal user inputs 601 using robot control application of FIG. 6, according to various embodiments. As shown, robot 705 (only fingers and wrist of robot 705 are shown which correspond to wrist 466 and fingers 468 of robot 460) is tasked with picking up either boxes 702A-702B or box 701. Desired motion plan 704 is generated by motion hint extractor 602 and included in one or more motion hints 607. Motion hints 607 are generated from various multi-modal user input(s) 601 collected through I/O devices 450, which can include tactile, gestural, and verbal commands. For example, a user can use a touchscreen to sketch a route to box 701, outlining a path that the robot 705 is expected to follow to reach goal, which is box 701. Similar to sketching a route, the user can use gestures, such as pointing or swiping, captured by motion sensors or cameras in I/O devices 450, as well as voice commands captured by microphones in I/O devices 450, which are then processed by motion hint extractor 602 to generate desired motion plan 704 that direct robot 705 to pick up box 701. Robot motion plans 703A-703C are generated by interactive denoiser 606 without updating based on the gradient of interaction loss. The thickness of each robot motion plan 703A-703C illustrates the likelihood of each motion plan. As shown, motion plan 703B tasked with picking up 702B has the highest likelihood. When interactive denoiser 606 does not update motion plan 703A-703C with the gradient of interaction loss, which captures the influence of desired motion plan 704, max likelihood estimator 604 selects motion plan 703B and generates robot trajectory 609 by trajectory generator 605 which is, in turn, applied to robot 705.

FIG. 7B illustrates an example of robot control using multi-modal user input(s) 601 using robot control application of FIG. 6, according to at least one embodiment. Interactive denoiser 606 uses desired motion plan 704 to compute the interaction loss, for example, interaction loss described in Equation 8. Interactive denoiser 606 then uses the gradient of interaction loss to update denoised motion plan candidates, for example, using Equation 10, for all the steps in the reverse process, for example, by setting λ to be non-zero for all i=N, N−1, . . . , 1 in Equation 10 in the reverse process. As shown, revised motion plans 705A-705C converge closely to desired motion plan 704 and are all tasked with picking up box 701, which was the goal the desired motion plan 704 indicated. Max likelihood estimator 604 selects revised motion plan 705B because revised motion plan 705B has the highest likelihood among 705A-705C and generates robot trajectory 609 by trajectory generator 605 which is, in turn, applied to robot 705.

FIG. 7C illustrates an example of robot control using multi-modal user input(s) 601 using robot control application of FIG. 6, according to various embodiments. Interactive denoiser 606 uses desired motion plan 704 to compute the interaction loss. Interactive denoiser 606 then uses the gradient of interaction loss to update denoised motion plan candidates, for example, using Equation 10, for a fixed initial number of steps 1≤M<N in the reverse process, for example, by setting A to be zero for all i=M, M−1, . . . , 1 in Equation 10 in the reverse process. As shown, revised motion plans 706A-706C only partially converge to desired motion plan 704. Revised motion plan 706C is tasked with picking up box 701, which the desired motion plan 704 indicated. Revised motion plans 706A and 706B are tasked with picking up boxes 702A and 702B, respectively. Max likelihood estimator 604 selects revised motion plan 706C because revised motion plan 706C has the highest likelihood and generates robot trajectory 609 by trajectory generator 605 which is, in turn, applied to robot 705.

FIG. 8 is a flow diagram of method steps for training the generative machine learning model 453 used during the control of robot 460, according to various embodiments. Although the method steps are described in conjunction with the systems of FIGS. 1-7, persons skilled in the art will understand that any system configured to perform the method steps in any order falls within the scope of the present embodiments.

As shown in FIG. 8, a method 800 begins with step 801, where model trainer 415 initializes simulation environment 505. The initialization includes but is not limited to configuring the parameters that define the simulated workspace, such as the dimensions of the environment, the properties of objects within simulation environment 505, the physics settings that will govern the interactions, and/or the like. Simulation environment 505 is designed to simulate various operational robot tasks from precise and repetitive tasks to dynamic and unpredictable situations that test the adaptability of robot 460. Simulation environment 505 can simulate various robot tasks including but not limited to object manipulation, such as picking, sorting, assembling, stacking, relocating items, and/or the like. Physics engine 504 is also initialized to provide accurate physical interactions, including but not limited to force, friction, inertia, and stability for the interactions. Initialization can also include setting up conditions for potential edge cases and errors that the robot 460 can encounter.

At step 802, model trainer 415 generates robot motion plan examples for a task using physics engine 504. Model trainer 415 uses simulation environment 505 in interaction with physics engine 504 to generate robot motion examples in which movements of a robot and interactions of the robot with objects are realistic and adhere to laws of physics. Physics engine 504 considers the mechanical properties, such as torque and force constraints for the robot, and environmental factors, such as gravity, inertia, and friction, and/or the like. In some embodiments, physics engine 504 assesses the effects of varying payloads on the arm of the robot and adjusts motion plans when the robot encounters unexpected obstacles. In at least one embodiment, when the robot interacts with multiple objects, physics engine 504 evaluates the stability of the objects, determining whether the objects will hold steady or topple under various interaction conditions with the robot. For example, in a block-stacking robot task, physics engine 504 predicts the stability of the block stack, and during transport tasks, physics engine 504 calculates the likelihood of objects moving based on the movements of the robot without directly interacting with the robot, such as when the robot is moving a surface on which the objects are located.

At step 803, model trainer 415 stores robot motion examples in robot motion plan data storage 502. Robot motion plan data storage 502 stores the training dataset including robot motion examples, which are used to train generative machine learning model 453. The training dataset includes, without limitation, robot poses, the velocities at which the robot operates, Cartesian movements, the resistance offered by the structure of robot 460 via the stiffness matrix, and various forces exerted upon or by robot 460. In various embodiments, robot motion plan data storage 502 stores motion scenes that provide context to the actions of the robot. Motion scenes include the position of robot 460 in the operational environment, the shapes and sizes of the objects that robot 460 manipulates, and the arrangement of the objects within the operational environment.

At step 804, model trainer 415 trains the generative machine learning model 453 based on the robot motion plan examples. In some examples, generative machine learning model 453 includes a diffusion model. The training process of a diffusion model includes teaching the diffusion model to process and reconstruct the original, clean robot motion plans from artificially noised versions of the motion plans. The diffusion model training starts by taking clean, structured robot motion plan examples from robot motion plan data storage 502 and introducing noise to the robot motion plan examples, for example, using Equation 1. In various embodiments, noise scheduler 506 methodically adds noise across several training steps, for example, based on a cosine scheduler as described in Equation 5. During the reverse phase of training, generative machine learning model 453 uses a parametric model to estimate and subtract the artificially introduced noise. During the training process, the parametric model adjusts the parameters iteratively using various algorithms, such as backpropagation to minimize a loss function, for example, the loss function described by Equation 2, in terms of the difference between the denoised output and the original clean robot motion plan examples. In some examples, during the training process, the parameters are updated by calculating the gradient of the objective function, such as the gradient described in Equation 3 and the update rule given in Equation 4.

FIG. 9 is a flow diagram of method steps for using multi-modal user input(s) 601 and the trained generative machine learning model 453 to control a robot 460, according to various embodiments. Although the method steps are described in conjunction with the systems of FIGS. 1-8, persons skilled in the art will understand that any system configured to perform the method steps in any order falls within the scope of the present embodiments.

As shown in FIG. 9, a method 900 begins with step 901, where robot control application 416 receives multi-modal user input(s) 601 and current motion scene 608. Multi-modal user input(s) 601 are received via the one or more I/O devices 450. Multi-modal user input(s) 601 include, but are not limited to, tactile interactions, such as sketches made on touchscreens, digital pens that allow users to draw trajectories for robot 460 or circle areas of interest on a digital map, delineating specific goals or paths, and/or the like. Multi-modal user input(s) 601 can also include gestural inputs, captured via sensors or cameras in the one or more I/O devices 450, which can include swipes or pointing gestures for dynamic command execution, such as transitioning phases of a task, selecting objects for manipulation, and/or the like. Additionally, multi-modal user input(s) can include voice commands, which are recorded via I/O devices 450, such as instructing the robot to perform actions like lifting objects or stopping operations, or even specifying tasks like “pick up the blue box.” Current motion scene 608 provides a snapshot of the operational environment for robot 460 and can include current positions, poses, and velocities of the joints of robot 460, and mapping the spatial arrangement of objects within the operation environment of robot 460.

At step 902, motion hint extractor 602 extracts motion hints 607 using multi-modal user input(s) 601. Multi-modal user input(s) 601 are processed to generate motion hints 607 that guide interactive denoiser 606 in revising robot motion plans. For example, for tactile inputs, such as sketches, the drawn trajectories or vectors are interpolated to generate a desired motion plan which is included in motion hints 607. Gesture inputs, such as hand swipes, pointing gestures, and/or the like, which can indicate a change in operational mode or identify specific goals for manipulation are processed using various algorithms that understand kinematics of robot 460 and trajectory planning to generate a desired robot motion plan included in motion hints 607. Additionally, verbal commands, such as phrases like “pick up the blue block” and/or the like, are processed using natural language processing technologies to generate desired robot motion plans included in motion hints 607. In some embodiments, motion hint extractor 602 uses various multi-modal user input(s) 601, such as tactile inputs, gestural inputs, and voice commands, to generate composite motion hints 607.

At step 903, the trained generative machine learning model 453 estimates noise based on current motion scene 608. The trained generative machine learning model 453 uses the parametric model which was trained according to method 800 to predict the noise based on the current motion scene 608 as described by Equation 7. The parametric model uses the current state of robot 460 and other data about the operation environment of robot 460 included in current motion scene 608 to generate the estimated noise 610.

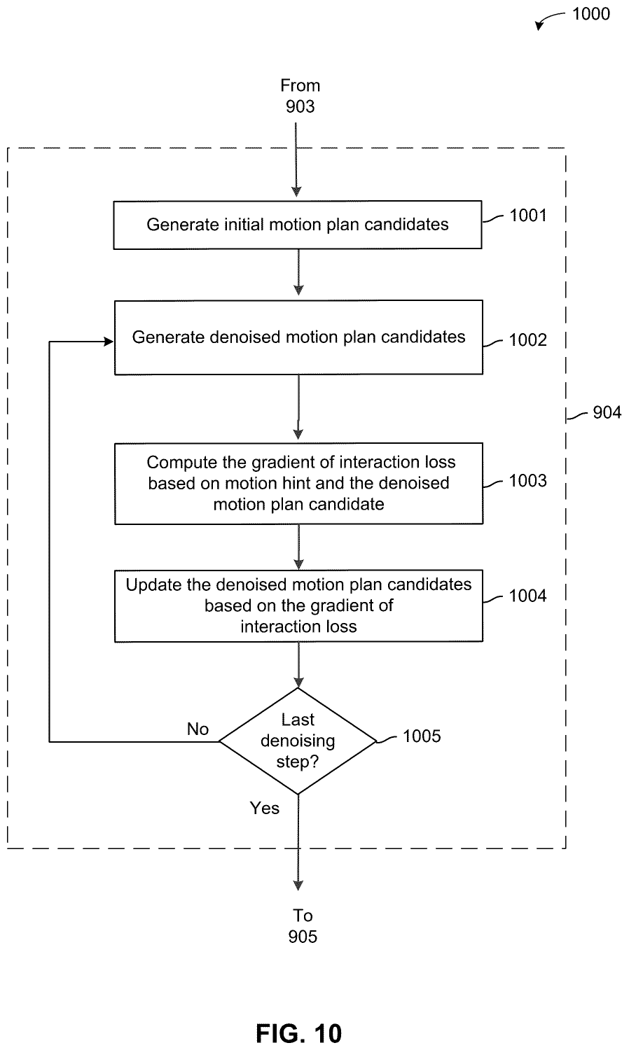

At step 904, interactive denoiser 606 generates revised robot motion plans 611. Interactive denoiser 606 receives estimated noise 610, motion hints 607, and current motion scene 608 and generates revised robot motion plans 611. Interactive denoiser 606 iteratively denoises robot motion plan candidates and then generates revised robot motion plans 611 based on motion hints 607 in a reverse process, which is discussed in more detail with respect to FIG. 10.

At step 905, max likelihood estimator 604 selects the revised motion plan 611 with the maximum likelihood. Given various revised motion plans 611 with various probabilities of prediction, max likelihood estimator 604 selects the revised robot motion plan which has the highest probability, which is the revised robot motion plan 611 that is considered to be the most likely to correspond to the desired motion plan indicated by motion hint(s) 607.

At step 906, trajectory generator 605 generates robot trajectory 609 over a fixed horizon. Trajectory generator 605 receives the selected revised robot motion plan from max likelihood estimator 604 and generates robot trajectory 609 which includes but is not limited to a sequence of movements that robot 460 can execute. Robot trajectory 609 includes joint positions, velocities, accelerations, the timing for each movement, and/or the like. In some embodiments, trajectory generator 605 discretizes the revised robot motion plan into discrete time steps. In at least one embodiment, trajectory generator 605 uses techniques such as smoothing, interpolation, and/or the like, to make the movements of robot 460 smooth and feasible. In some examples, trajectory generator 605 uses cubic splines or polynomial interpolations to generate a smooth trajectory for robot 460 to follow between waypoints specified in the revised robot motion plan. In various embodiments, trajectory generator 605 uses a MPC to optimize the trajectory over a planned horizon, considering future states of robot 460 to make real-time adjustments. Once robot trajectory 609 is generated, trajectory generator 605 uses kinematic models of the robot 460 to translate robot trajectory 609 into joint commands for joints 462, 464, 466, and the fingers 468 of robot 460.

At step 907, robot control application 416 command robot 460 to perform a step of robot trajectory 609. The joint commands generated by trajectory generator 605 are relayed to the control system of robot 460, which directly commands the joints 462, 464, 466 to execute one step of robot trajectory 609.

At step 908, robot control application 416 checks whether there are new multi-modal user input(s) 601. If there are no new multi-modal user input(s) 601, the method 900 returns to step 903. If there are new multi-modal user input(s) 601, the method 900 returns to step 901 to process the new multi-modal user input(s) 601.

FIG. 10 is a flow diagram of method steps for interactive denoising to generate revised robot motion plans 611, according to various embodiments. Method 1000 is performed as part of step 904 from method 900. Although the method steps are described in conjunction with the systems of FIGS. 1-7, persons skilled in the art will understand that any system configured to perform the method steps in any order falls within the scope of the present embodiments.

As shown, a method 1000 begins with step 1001, where interactive denoiser 606 generates initial motion plan candidates. Interactive denoiser 606 uses the current state of robot 460 from the current motion scene 608 to generate initial motion plan candidates. In various embodiments, the initial motion plan candidates are generated randomly using a probability distribution, such as a normal distribution, starting from the state of robot 460 included in current motion scene 608. In at least one embodiment, interactive denoiser 606 randomly sets goals within the operational environment of robot 460 during step 1001.

At step 1002, interactive denoiser 606 generates denoised motion plan candidates. Following the generation of initial motion plan candidates, interactive denoiser 606 denoises the motion plan candidates. For every step from the final one down to the first, interactive denoiser 606 removes a portion of the noise introduced during the training phase. The denoising process includes reversing the noise addition mechanism by using estimated noise 610, subtracting, and weighting the estimated noise 610 from each motion plan candidate, for example, as described by Equation 8

At step 1003, interactive denoiser 606 computes the gradient of the interaction loss based on motion hints 607 and the denoised motion plan candidates. In various embodiments, interactive denoiser 606 compares the denoised motion plan candidates and the desired motion plan included in motion hints 607 and computes an interaction loss, such as the interaction loss described by Equation 9, which can include a distance measure, such as a vector norm, and/or the like, between the denoised motion plan candidates and the desired motion plan included in motion hints 607. Interactive denoiser 606 then computes the gradient of interaction loss.

At step 1004, interactive denoiser 606 updates the denoised motion plan candidates based on the gradient of interaction loss. The update process includes adjusting the denoised motion plan candidates iteratively to minimize the interaction loss, for example, using the update rule described by Equation 10. Interactive denoiser 606 uses a parameter between zero to one, which controls the extent to which the gradients of interaction loss influence the updates of the denoised motion plan candidates. In various embodiments, the parameter is set to zero after a predetermined number of iterations to limit the influence of the multi-modal user inputs 601 to only the early stages of the reverse process. In at least one embodiment, interactive denoiser 606 ensures that the initial state of each denoised motion plan candidate corresponds closely with the current state of robot 460 as captured in the current motion scene 608 in a process, known as “inpainting” by setting the initial condition of the denoised motion plan candidates to the current state of robot 460. Furthermore, in various embodiments, interactive denoiser 606 sets the final state of the denoised motion plan candidates the goal included in motion hints 607.

At step 1005, interactive denoiser 606 checks whether the reverse process has reached the last denoising step. If the reverse process has not reached the last denoising step, method 1000 returns to step 1002 and generates new denoised motion plan candidates. If the reverse process has reached the last denoising step, interactive denoiser 606 outputs the current denoised motion plan candidates as revised robot motion plans 611.

In sum, techniques are disclosed for controlling a robot using multi-modal user inputs. A generative machine learning model, such as a diffusion model, is used to revise robot motion plans based on the multi-modal user inputs. The multi-modal user inputs include but are not limited to motion sketches, gestures, and verbal commands, which can indicate spatial directives and paths, high-level tasks, and/or identify specific objects or goals within the operational scene. The multi-modal user inputs are analyzed to determine one or more motion hints for the robot. The techniques estimate noise associated with the operational scene using a trained generative machine learning model, which is used to help iteratively denoise one or more candidate motion plans. At each denoising iteration, the one or more candidate motion plans are updated based on estimated noise from the trained generative machine learning model and a gradient of an interaction loss. The gradient of the interaction loss provides feedback on the candidate motion plans relative to the one or more motion hints. The denoising continues until a pre-defined number of iterations is reached. The robot is then commanded to perform a motion step using the candidate motion plan with the maximum likelihood. In various embodiments, a virtual or a physical environment is used to train the generative machine learning model using examples of various robotic tasks.

At least one technical advantage of the disclosed techniques relative to the prior art is that, with the disclosed techniques, the need for strong and detailed human input during the robot motion planning process is removed. The disclosed techniques do not require extensive human interaction, which is often repetitive and physically demanding for a user, and instead work from easy to generate multi-modal user inputs that indicate the desired intent of the user without being physically demanding. In addition, the multi-modal user inputs give the user more flexibility when providing a motion hint over conventional techniques using only unimodal user inputs. These technical advantages provide one or more technological improvements over prior art approaches.

1. In some embodiments, a computer-implemented method for controlling a robot comprises receiving one or more multi-modal inputs from a user, extracting a motion hint from the one or more multi-modal inputs, generating estimated noise based on a current motion scene for the robot, generating a plurality of candidate motion plans, iteratively denoising the plurality of candidate motion plans based on the estimated noise and the motion hint to generate a plurality of revised robot motion plans, selecting a robot motion plan from the plurality of revised robot motion plans, generating a robot trajectory from the selected robot motion plan, and commanding the robot to perform a first step of the robot trajectory.

2. The method of clause 1, wherein the plurality of candidate motion plans are generated randomly from a current state of the robot.

3. The method of clauses 1 or 2, wherein the one or more multi-modal inputs comprises a motion sketch indicating a sequence of points in the current motion scene.

4. The method of any of clauses 1-3, wherein the one or more multi-modal inputs comprises a gesture or a voice command identifying an object or a goal in the current motion scene.

5. The method of any of clauses 1-4, wherein the motion hint is a composite motion hint generated from two or more multi-modal inputs from the user.

6. The method of any of clauses 1-5, wherein generating the estimated noise comprises presenting the current motion scene to a generative machine learning model.

7. The method of any of clauses 1-6, wherein the generative machine learning model is a diffusion model.

8. The method of any of clauses 1-7, wherein the generative machine learning model is trained based on robot motion examples to which noise has been added, the robot motion examples being determined from observing robot tasks performed in a simulation environment.

9. The method of any of clauses 1-8, wherein iteratively denoising a first candidate motion plan of the plurality of candidate motion plans comprises removing a portion of the noise from the first candidate motion plan based on the estimated noise to generate a first denoised candidate motion plan, computing a gradient of an interaction loss between the motion hint and the first denoised candidate motion plan, and updating the first denoised candidate motion plan based on the gradient.

10. The method of any of clauses 1-9, wherein iteratively denoising the first candidate motion plan further comprises setting a first step of the first denoised candidate motion plan to a current state of the robot.

11. The method of any of clauses 1-10, wherein iteratively denoising the first candidate motion plan further comprises repeating the removing of the portion of the noise, the computing of the gradient of the interaction loss, and the updating of the first denoised candidate motion plan until a last denoising step is performed.

12. The method of any of clauses 1-11, wherein a parameter applied to the gradient of the interaction loss reduces the gradient of the interaction loss to zero after a predetermined number of iterations.

13. The method of any of clauses 1-12, wherein the selected robot motion plan has a highest likelihood among the plurality of revised robot motion plans.

14. In some embodiments, one or more non-transitory computer readable media store instructions that, when executed by one or more processors, cause the one or more processors to perform the steps of receiving one or more multi-modal inputs from a user, extracting a motion hint from the one or more multi-modal inputs, generating estimated noise based on a current motion scene for a robot, generating a plurality of candidate motion plans, iteratively denoising the plurality of candidate motion plans based on the estimated noise and the motion hint to generate a plurality of revised robot motion plans, selecting a robot motion plan from the plurality of revised robot motion plans, generating a robot trajectory from the selected robot motion plan, and commanding the robot to perform a first step of the robot trajectory.

15. The one or more non-transitory computer-readable media of clause 14, wherein the plurality of candidate motion plans are generated randomly from a current state of the robot.

16. The one or more non-transitory computer-readable media of clauses 14 or 15, wherein the one or more multi-modal inputs include at least one of a motion sketch indicating a sequence of points in the current motion scene or gesture or a voice command identifying an object or a goal in the current motion scene.

17. The one or more non-transitory computer-readable media of any of clauses 14-16, wherein generating the estimated noise comprises presenting the current motion scene to a generative machine learning model.

18. The one or more non-transitory computer-readable media of any of clauses 14-17, wherein iteratively denoising a first candidate motion plan of the plurality of candidate motion plans comprises removing a portion of the noise from the first candidate motion plan based on the estimated noise to generate a first denoised candidate motion plan, computing a gradient of an interaction loss between the motion hint and the first denoised candidate motion plan, and updating the first denoised candidate motion plan based on the gradient.

19. The one or more non-transitory computer-readable media of any of clauses 14-18, wherein the selected robot motion plan has a highest likelihood among the plurality of revised robot motion plans.

20. In some embodiments, a system comprises one or more memories storing instructions, and one or more processors that are coupled to the one or more memories and, when executing the instructions, are configured to receive one or more multi-modal inputs from a user, extract a motion hint from the one or more multi-modal inputs, generate estimated noise based on a current motion scene for a robot, generate a plurality of candidate motion plans, iteratively denoise the plurality of candidate motion plans based on the estimated noise and the motion hint to generate a plurality of revised robot motion plans, select a robot motion plan from the plurality of revised robot motion plans, generate a robot trajectory from the selected robot motion plan, and command the robot to perform a first step of the robot trajectory.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a robot, the method comprising:
receiving one or more multi-modal inputs from a user;
extracting a motion hint from the one or more multi-modal inputs;
generating estimated noise based on a current motion scene for the robot;
generating a plurality of candidate motion plans;
iteratively denoising the plurality of candidate motion plans based on the estimated noise and the motion hint to generate a plurality of revised robot motion plans;
selecting a robot motion plan from the plurality of revised robot motion plans;
generating a robot trajectory from the selected robot motion plan; and
commanding the robot to perform a first step of the robot trajectory.

2. The method of claim 1, wherein the plurality of candidate motion plans are generated randomly from a current state of the robot.

3. The method of claim 1, wherein the one or more multi-modal inputs comprises a motion sketch indicating a sequence of points in the current motion scene.

4. The method of claim 1, wherein the one or more multi-modal inputs comprises a gesture or a voice command identifying an object or a goal in the current motion scene.

5. The method of claim 1, wherein the motion hint is a composite motion hint generated from two or more multi-modal inputs from the user.

6. The method of claim 1, wherein generating the estimated noise comprises presenting the current motion scene to a generative machine learning model.

7. The method of claim 6, wherein the generative machine learning model is a diffusion model.

8. The method of claim 6, wherein the generative machine learning model is trained based on robot motion examples to which noise has been added, the robot motion examples being determined from observing robot tasks performed in a simulation environment.

9. The method of claim 1, wherein iteratively denoising a first candidate motion plan of the plurality of candidate motion plans comprises:
removing a portion of the noise from the first candidate motion plan based on the estimated noise to generate a first denoised candidate motion plan;
computing a gradient of an interaction loss between the motion hint and the first denoised candidate motion plan; and
updating the first denoised candidate motion plan based on the gradient.

10. The method of claim 9, wherein iteratively denoising the first candidate motion plan further comprises setting a first step of the first denoised candidate motion plan to a current state of the robot.

11. The method of claim 9, wherein iteratively denoising the first candidate motion plan further comprises repeating the removing of the portion of the noise, the computing of the gradient of the interaction loss, and the updating of the first denoised candidate motion plan until a last denoising step is performed.

12. The method of claim 11, wherein a parameter applied to the gradient of the interaction loss reduces the gradient of the interaction loss to zero after a predetermined number of iterations.

13. The method of claim 1, wherein the selected robot motion plan has a highest likelihood among the plurality of revised robot motion plans.

14. One or more non-transitory computer readable media storing instructions that, when executed by one or more processors, cause the one or more processors to perform the steps of:
receiving one or more multi-modal inputs from a user;
extracting a motion hint from the one or more multi-modal inputs;
generating estimated noise based on a current motion scene for a robot;
generating a plurality of candidate motion plans;
iteratively denoising the plurality of candidate motion plans based on the estimated noise and the motion hint to generate a plurality of revised robot motion plans;
selecting a robot motion plan from the plurality of revised robot motion plans;
generating a robot trajectory from the selected robot motion plan; and
commanding the robot to perform a first step of the robot trajectory.

15. The one or more non-transitory computer-readable media of claim 14, wherein the plurality of candidate motion plans are generated randomly from a current state of the robot.

16. The one or more non-transitory computer-readable media of claim 14, wherein the one or more multi-modal inputs include at least one of a motion sketch indicating a sequence of points in the current motion scene or gesture or a voice command identifying an object or a goal in the current motion scene.

17. The one or more non-transitory computer-readable media of claim 14, wherein generating the estimated noise comprises presenting the current motion scene to a generative machine learning model.

18. The one or more non-transitory computer-readable media of claim 14, wherein iteratively denoising a first candidate motion plan of the plurality of candidate motion plans comprises:
removing a portion of the noise from the first candidate motion plan based on the estimated noise to generate a first denoised candidate motion plan;
computing a gradient of an interaction loss between the motion hint and the first denoised candidate motion plan; and
updating the first denoised candidate motion plan based on the gradient.

19. The one or more non-transitory computer-readable media of claim 14, wherein the selected robot motion plan has a highest likelihood among the plurality of revised robot motion plans.

20. A system comprising:
one or more memories storing instructions, and
one or more processors that are coupled to the one or more memories and, when executing the instructions, are configured to:
receive one or more multi-modal inputs from a user;
extract a motion hint from the one or more multi-modal inputs;
generate estimated noise based on a current motion scene for a robot;
generate a plurality of candidate motion plans;
iteratively denoise the plurality of candidate motion plans based on the estimated noise and the motion hint to generate a plurality of revised robot motion plans;
select a robot motion plan from the plurality of revised robot motion plans;
generate a robot trajectory from the selected robot motion plan; and
command the robot to perform a first step of the robot trajectory.
